(19) United States
(12) Patent Application Publication
(10) Pub. No.: US 2022/0096954 A1
(43) Pub. Date: Mar. 31, 2022

(54) USE OF CONDUCTIVITY AS A PROXY MEASURE FOR SOLIDS IN ETHANOL STILLAGE EVAPORATOR STREAMS

(71) Applicant: BL TECHNOLOGIES, INC., MINNETONKA, MN (US)

(72) Inventors: Dan WALTER, MINNETONKA, MN (US); Aaron ANDREWS, MINNETONKA, MN (US)

(21) Appl. No.: 17/428,606

(22) PCT Filed: Feb. 4, 2020
(86) PCT No.: PCT/US2020/016495

§ 371 Date: Aug. 4, 2021

Related U.S. Application Data
(60) Provisional application No. 62/805,526, filed on Feb. 14, 2019.

(51) Int. Cl. B01D 1/00; B01D 1/26

(52) U.S. Cl. CPC B01D 1/0082; B01D 1/26

(57) ABSTRACT

A method for control and optimization of a stillage evaporation process, the method providing monitoring a conductivity of a stillage stream to obtain a conductivity value; correlating the conductivity value to a dry solids percentage (% DS) present in a stillage evaporator system to obtain an evaporator solids profile; and utilizing the evaporator solids profile to obtain a mass-balance solids profile of a stillage evaporator system to control and optimize a dry solids evaporation process.

### CROSS-REFERENCE TO RELATED APPLICATIONS

This application claims the priority benefit of Application Ser. No. 62/805,526 filed Feb. 14, 2019, the entirety of which is herein incorporated by reference.

### FIELD OF INVENTION

The disclosed technology generally described hereinafter provides for a system and method for the control and optimization of a stillage evaporation process, and more specifically, using conductivity as a proxy measure of % DS in order to better manage load balances and optimize “Clean in Place” (CIP) processes of stillage evaporator systems.

### BACKGROUND OF THE INVENTION

Currently, evaporator solids balance information is difficult to collect and/or measure, requiring two to four hours to measure resulting in ethanol producers using pre-determined “Clean in Place” (CIP) schedules to clean evaporator vessels on a pre-planned schedule and frequency with no regard to actual cleanliness conditions of any particular vessel. This can result in loss of system efficiency due to spending time cleaning a vessel that is not substantially fouled, rather than directing the effort to the most fouled vessel, if required. The impact on plant productivity and efficiency results in lower ethanol production and corn oil recovery due to the downtime associated with the CIP processes.

Currently, coreolis meters are able to measure the actual mass flow of each evaporation vessel directly, where the actual flow rates and densities of the advancing liquor stream through the successive vessels as it concentrates can be provided. From these measurements, the mass-balance profile can be generated. However, utilization of this type of equipment would require substantially larger investment due to the configuration needs and costs of such systems. Nine individual meters and associated piping consistent with meter installation requirements would be required. The relative cost of this equipment is nearly 10× of conductivity systems and the installation requirements are substantially greater as additional piping would very likely be required to provide the straight runs needed for such equipment.

Further, condensate flow measurements may also provide similar results, by measuring the mass balance across each evaporation vessel. However, the challenge with such an approach is the aggressive nature of process condensate and uneven real-time flow measurement capability of condensate flows from individual evaporation vessels.

Thus, the present technology overcomes the prior problems/issues discussed, and allows for the ethanol producer to better manage their stillage evaporator system to maximize the evaporation process efficiency with respect to final syrup stream % DS exiting the evaporation process, which will relate to a reduction in the total energy required to dry co-products that include the syrup stream.

### SUMMARY OF THE INVENTION

The disclosed technology generally described hereinafter provides for a system and method control and optimization of a stillage evaporation process, and more specifically, a system and method for generating solids balance and evaporator load-performance data across a plurality of evaporator vessels within a stillage evaporation process.

In one aspect of the disclosed technology, a method for control and optimization of a stillage evaporation process is provided. The method comprising monitoring a conductivity of a stillage stream to obtain a conductivity value; correlating the conductivity value to a dry solids percentage (% DS) present in a stillage evaporator system to obtain an evaporator solids profile; and utilizing the evaporator solids profile to obtain a mass-balance solids profile of a stillage evaporator system to control and optimize an evaporation process.

### BRIEF DESCRIPTION OF THE DRAWINGS

These and other features of the disclosed technology, and the advantages, are illustrated specifically in embodiments now to be described, by way of example, with reference to the accompanying diagrammatic drawings, in which:

FIG. 1 is a graph providing results of an illustrative embodiment of the disclosed technology;

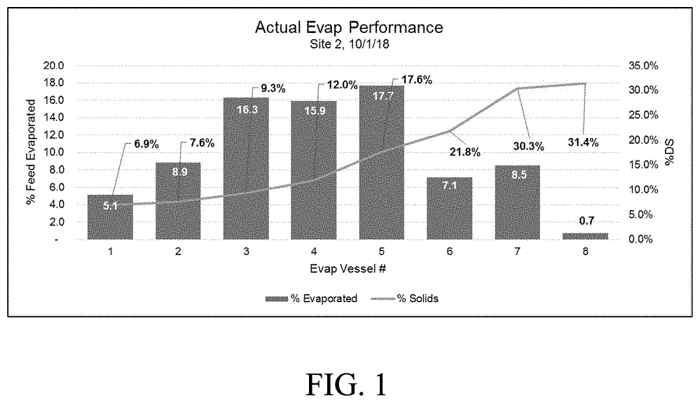

FIG. 2 is a graph providing results of an illustrative embodiment of the disclosed technology;

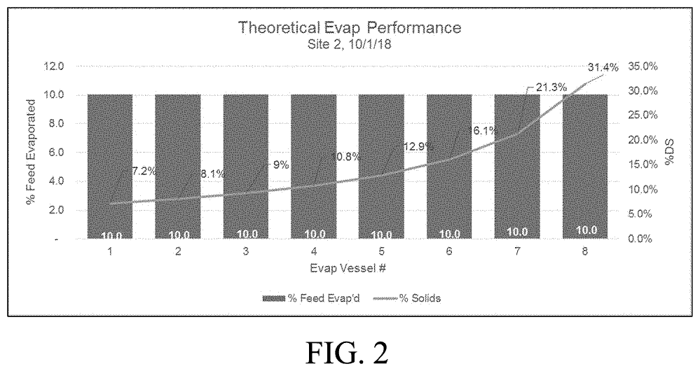

FIG. 3 is a graph providing results of an illustrative embodiment of the disclosed technology;

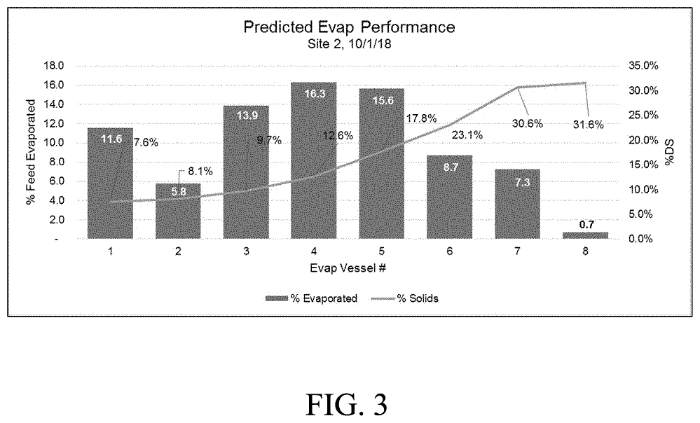

FIG. 4 is a graph providing results of an illustrative embodiment of the disclosed technology; and

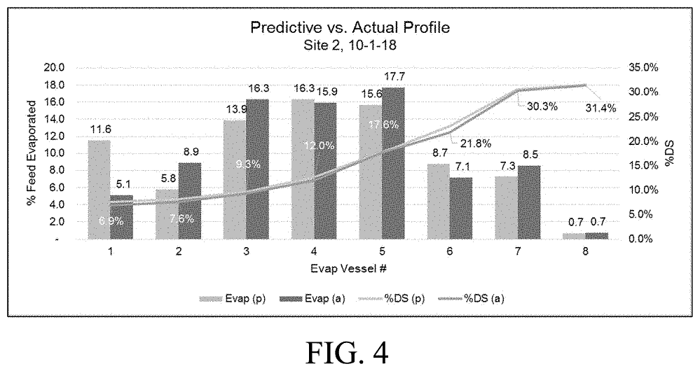

FIG. 5 is a graph providing results of an illustrative embodiment of the disclosed technology.

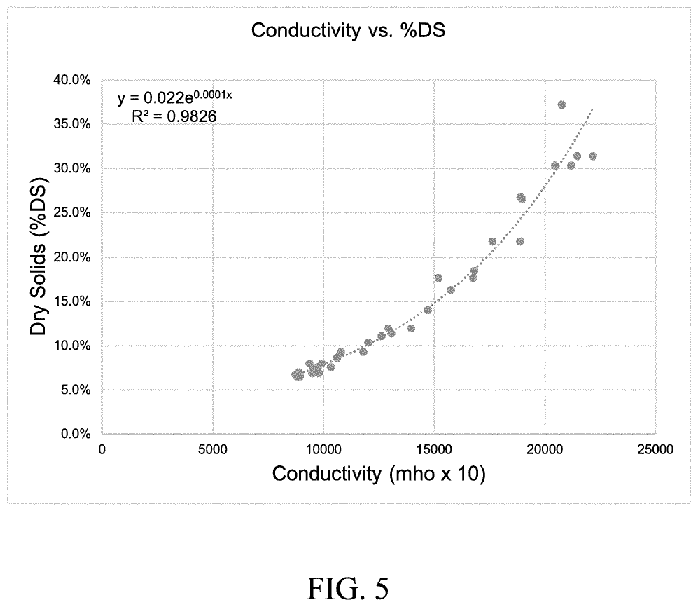

### DETAILED DESCRIPTION OF EXEMPLARY EMBODIMENTS

The disclosed technology generally provides for a system and method for the control and optimization of a stillage evaporation process. The disclosed technology is directed towards monitoring the conductivity of stillage solid streams with a conductance monitor, and using this information to control and optimize the process evaporation, so as to optimize energy consumption and minimize fouling. The disclosed technology further provides for using conductivity as a proxy measure of % DS in order to better manage load balances and optimize “Clean in Place” (CIP) processes of stillage evaporator systems.

The disclosed technology, through routine analysis of stillage evaporator samples and the data obtained therein, determined a correlation of individual stillage stream conductivity to the corresponding % Dry Solids (% DS) of each sample across an eight (8) vessel double-effect evaporator system. It was determined the conductivity measurements provide a statistically accurate calculation of the % DS across all eight evaporator vessels. This data is then used to construct a mass-balance solids profile across an evaporator system that is used to effectively measure actual evaporation rates within each vessel. Further, this information is used to support evaporator operation decisions regarding system cleanliness, hydraulic balance and provide predictive information to optimize “Clean in Place” (CIP) processes, such as CIP scheduling, vessel selection priority for CIPs, and/or the like.

By proving the correlation of conductivity to % DS, rapid results of evaporator solids profiles are generated such that, at any given time, the results will identify which vessels are underperforming with respect to evaporator duty. Further, with on-line conductivity instrumentation, real-time results of the solids profile, as well as more predictive performance expectations based on operating conditions and operating history through the use of multiple regression analysis of each evaporator vessel's performance, are provided. In some embodiments, the real-time % DS profile across the stillage evaporator will support operational decision making based on these outcomes, which can result in (1) more effective evaporator vessel runs, and (2) increasing the final % DS based on cleanliness capability.

By monitoring the actual individual vessel evaporation rate (based on vessel cleanliness), decisions on when to CIP any given vessel can be managed to extend the time to optimum for the respective vessel. This will reduce the CIP frequency for many of the evaporator vessels that may not exhibit the same level of fouling as other vessels, and may also increase the CIP frequency of those vessels that do exhibit higher fouling rates. In either case, the time and effort required for CIP processes are directed to where the most cleanliness benefit will be realized.

The purpose of the stillage evaporator is to concentrate the stillage solids level, such that the final liquor can be applied to other solids streams that comprise Dried Distillers Grains with Solubles (DDGS), a valuable co-product of the ethanol process. The DDGS solids moisture content market requirement is 10-12% moisture. At a typical syrup moisture content of 65%-70% exiting the evaporator system, additional energy is required to produce a marketable DDGS coproduct. The evaporator removes moisture using half the energy (double effect) that will be required in down-stream DDGS dryer systems. Therefore, increasing the % DS (i.e. reducing the moisture content) in the evaporator system effluent syrup will decrease the energy requirement down-stream, resulting in reduced manufacturing/operating costs required to produce the DDGS. This is not done today in current processes due to the increased risk on evaporator performance the higher % DS syrup level will have on increased fouling. By more effectively managing the total evaporator cleanliness, this risk is reduced and increasing/maintaining higher % DS results.

The cost and simplicity of the conductivity measurement as in the present technology, allows the producer to effectively measure their system performance with a robust real-time conductivity analyzer array to optimize the benefits described above. It also provides real performance data to measure improvements to the evaporation process that are realized through the use of on-line deposit control agents, CIP additives, and other adjunct treatments designed to make such improvements. In contrast to the disclosed technology, with such adjunct treatments used with current processes, actual impact is difficult to prove due to the myriad variables of the stillage evaporator system.

In some embodiments, the method and process described herein may include measuring the actual mass balances across the eight evaporator vessels, including the % DS mass balance described herein, measuring of the resulting condensate or vapor generated by the evaporation processes, density measurements of the liquor streams, or the like.

### EXAMPLES

The present invention will be further described in the following examples, which should be viewed as being illustrative and should not be construed to narrow the scope of the disclosed technology or limit the scope to any particular embodiments.

Multiple analyses of two separate stillage evaporator system % Dry Solids (% DS) profiles have been run and compared to corresponding specific conductance measurements. The charted data was used to develop a mathematical (exponential) trend formula with an R2 greater than 0.98. The results of this correlation are then used in a mass balance formula for the evaporator system to generate a solids balance and evaporator load-performance data across all evaporator vessels. Ultimately this data will be generated using on-line instrumentation and providing real-time data.

The results of testing also identified the need for individual site-based correlation formulae that, while different from site to site, have been proven to provide the statistically significant accuracy for each respective site.

Table 1 provides data obtained from the disclosed technology, wherein the calculation parameter for y=[constant]e^{(multiplier×X)}, where the constant value is 0.0228, and the multiplier is 0.00012257.

TABLE 1

| | | | Measured | Calculated | |
|---|---|---|---|---|---|
| Site | Date | Conductivity | % DS | % DS | % error |
| 2 | 4-Jun | 8870 | 7.0% | 6.8% | −3.1% |
| 2 | 4-Jun | 9357 | 8.0% | 7.2% | −10.3% |
| 2 | 4-Jun | 10770 | 9.1% | 8.5% | −6.1% |
| 2 | 4-Jun | 12010 | 10.4% | 9.9% | −4.2% |
| 2 | 4-Jun | 13060 | 11.4% | 11.3% | −0.8% |
| 2 | 4-Jun | 15740 | 16.3% | 15.7% | −3.7% |
| 2 | 4-Jun | 18970 | 26.5% | 23.3% | −12.1% |
| 2 | 27-Aug | 8733 | 6.7% | 6.6% | −1.0% |
| 2 | 27-Aug | 9511 | 7.3% | 7.3% | −0.5% |
| 2 | 27-Aug | 9920 | 8.0% | 7.7% | −3.8% |
| 2 | 27-Aug | 10610 | 8.6% | 8.4% | −2.9% |
| 2 | 27-Aug | 12610 | 11.1% | 10.7% | −3.5% |
| 2 | 27-Aug | 14700 | 14.0% | 13.8% | −1.6% |
| 2 | 27-Aug | 16810 | 18.5% | 17.9% | −3.1% |
| 2 | 27-Aug | 18890 | 26.8% | 23.1% | −13.7% |
| 2 | 27-Aug | 20760 | 37.2% | 29.0% | −21.9% |
| 2 | 18-Sep | 8929 | 6.5% | 6.8% | 4.6% |
| 2 | 18-Sep | 9488 | 6.9% | 7.3% | 6.4% |
| 2 | 18-Sep | 9741 | 7.6% | 7.5% | −0.4% |
| 2 | 18-Sep | 10790 | 9.3% | 8.6% | −7.9% |
| 2 | 18-Sep | 12910 | 12.0% | 11.1% | −7.3% |
| 2 | 18-Sep | 15190 | 17.6% | 14.7% | −16.8% |
| 2 | 18-Sep | 17630 | 21.8% | 19.8% | −9.2% |
| 2 | 18-Sep | 20450 | 30.3% | 28.0% | −7.8% |
| 2 | 18-Sep | 22160 | 31.4% | 34.5% | 9.8% |
| 2 | 1-Oct | 8798 | 6.5% | 6.7% | 2.9% |
| 2 | 1-Oct | 9786 | 6.9% | 7.6% | 10.3% |
| 2 | 1-Oct | 10330 | 7.6% | 8.1% | 7.0% |
| 2 | 1-Oct | 11800 | 9.3% | 9.7% | 4.2% |
| 2 | 1-Oct | 13960 | 12.0% | 12.6% | 5.4% |
| 2 | 1-Oct | 16760 | 17.6% | 17.8% | 0.9% |
| 2 | 1-Oct | 18880 | 21.8% | 23.1% | 5.8% |
| 2 | 1-Oct | 21190 | 30.3% | 30.6% | 0.9% |
| 2 | 1-Oct | 21450 | 31.4% | 31.6% | 0.6% |

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A method for control and optimization of a stillage evaporation process, the method comprising:
monitoring a conductivity of a stillage stream to obtain a conductivity value;
correlating the conductivity value to a dry solids percentage (% DS) present in a stillage evaporator system to obtain an evaporator solids profile; and
utilizing the evaporator solids profile to obtain a mass-balance solids profile of a stillage evaporator system to control and optimize an evaporation process.

2. The method as recited in claim 1, wherein the mass-balance solids profile is further used to measure an evaporation rate within a plurality of evaporation vessels.

3. The method as recited in claim 2, wherein the evaporation rate is used to identify and control performance of the plurality of evaporator vessels.
